(19) United States
(12) Patent Application Publication
(10) Pub. No.: US 2026/0198486 A1
(43) Pub. Date: Jul. 16, 2026

(54) A STABLE AGROCHEMICAL COMPOSITION

(71) Applicant: UPL LIMITED, Mumbai (IN)

(72) Inventors: Sujata Vishwas Jadhav, Mumbai (IN); Samadhan Patil, Mumbai (IN)

(73) Assignee: UPL LIMITED, Mumbai (IN)

(21) Appl. No.: 19/136,157

(22) PCT Filed: Dec. 13, 2023
(86) PCT No.: PCT/IN2023/051176

§ 371 Date: Jun. 5, 2025

(30) Foreign Application Priority Data
Dec. 20, 2022 (IN) 202221074001

(51) Int. Cl. A01P 13/00; A01N 25/04; A01N 25/30; A01N 43/40; A01N 43/80

(52) U.S. Cl. CPC A01N 25/04; A01N 25/30; A01N 43/40; A01N 43/80; A01P 13/00

(57) ABSTRACT

The present disclosure relates to a stable agrochemical composition and in particular, a stable herbicidal composition of at least one isoxazoline herbicide and at least one phenyl ether herbicide. The present disclosure also relates to a process for preparation of the agrochemical composition and to a method for controlling weeds using the agrochemical composition thereof.

### FIELD OF THE DISCLOSURE

The present disclosure relates to a stable agrochemical composition and in particular, a stable herbicidal composition comprising at least one isoxazoline herbicide and at least one phenyl ether herbicide. More particularly, the present disclosure relates to a stable herbicidal composition comprising at least one long-chain fatty acid synthesis inhibitor and at least one phytoene desaturase inhibitor. The present disclosure also relates to a process for preparation of the agrochemical composition and a method for controlling weeds using the agrochemical composition thereof.

### BACKGROUND OF THE DISCLOSURE

Herbicides are chemical substances, which are used to specifically control the unwanted plants/weeds. The mode of action for herbicides is a biochemical or physical mechanism, which it uses to control unwanted plants/weeds. Most herbicides control unwanted plants/weeds by disrupting or altering one or more of the metabolic processes of plants. Some herbicides disrupt the cellular membranes of unwanted plants, while some herbicides allow cellular contents of the unwanted plant membranes to leak out. However, the herbicides do not directly disrupt other metabolic processes of the unwanted plants/weeds.

Furthermore, there are certain species of unwanted plants/weeds or groups of unwanted plants/weeds, which are not susceptible to certain herbicides. This may be because either the herbicides use different biochemical pathways, or the herbicides have slightly different enzymes. Herbicides are often chosen for use based on their mode of action. In situations, when one herbicide is ineffective, another herbicide with a different mode of action may provide better results. Therefore, when and how any herbicide should be applied may be determined by the mode of action of the herbicide.

Therefore, herbicides play an important role in agricultural practices across the world in controlling unwanted plants/weeds, which contaminate the yielding lands. Compositions containing herbicides have been used for decades for weed control, however, they have some disadvantages. They have none/insufficient herbicidal activity against specific harmful/unwanted plants, the spectrum of harmful/unwanted plants which can be controlled with the herbicides is not broad enough, the selectivity of herbicides in and the compatibility with crops is too low, thereby causing unwanted damage and/or unwanted reduced harvest yields of the crops, the initial herbicidal activity is not acceptable or not strong enough and/or the herbicidal activity does not last long enough. For these reasons, there is a constant need to develop herbicidal compositions which overcome the aforementioned disadvantages.

Pyroxasulfone is an isoxazoline herbicide belonging to the group of pyrazolium. Pyroxasulfone is chemically known as 3-[5-(difluoromethoxy)-1-methyl-3-(trifluoromethyl)pyrazol-4-ylmethylsulfonyl]-4,5-dihydro-5,5-dimethyl-1,2-oxazole. It is a pre-emergence herbicide that inhibits the biosynthesis of very long-chain fatty acids (VLCFA). It can be used to effectively control grass and broad-leaved weeds in corn, soybean, and wheat fields.

Diflufenican or N-(2,4-Difluorophenyl)-2-(3-(trifluoromethyl)phenoxy)nicotinamide is a pyridine carboxamide having the following structure:

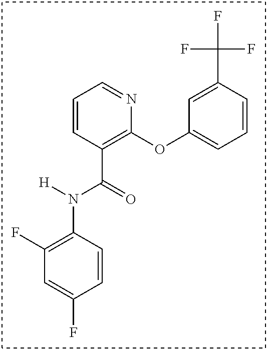 [SMILES: O=C(Nc1ccc(F)cc1F)c1cccnc1Oc1cccc(C(F)(F)F)c1]

Diflufenican is a selective herbicide that acts as a phytoene desaturase inhibitor and is used for specifically controlling broad leaved weeds. It may be used alone, or in combination with other herbicides such as pendimethalin, mecoprop-P, chlorotoluron, bromoxynil and ioxynil sodium, flufenacet, flurtamone, iodosulfuron methyl sodium, glyphosate, oxadiazon, isoproturon, 2-methyl-4-chlorophenoxyacetic acid (MCPA), mesosulfuron-methyl, etc., to obtain effective control of a wide variety of herbicide-resistant and herbicide-tolerant weeds. Further, owing to its different mode of action, it can provide for a promising strategy to control weeds in a wide variety of crops and also reduce phytotoxicity.

Furthermore, it has now been found that certain herbicide compositions exhibit the desired herbicidal activity and are able to control harmful/unwanted plants or unwanted weeds in a more efficacious manner.

Furthermore, in the agrochemical applications, liquid concentrate compositions, are sometimes preferred over other types of formulations due to ease of making and using. Concentrated compositions have grown in popularity due to various benefits such as being free from dust, which may cause health hazard to people exposed to it during manufacturing as well as at the end user level. Concentrated compositions can be conveniently diluted to bigger volumes during application without involving sophisticated machinery before final use. Concentrated compositions such as suspension concentrate (SC) and flowable Liquids (FL) are dispersion of an insoluble solid into a liquid carrier.

Although compositions containing mixtures of two or more herbicides in suspension concentrates have been practiced in the art, problems such as suspensibility, physical instability of such mixtures during manufacture, shelf life at dilution or at the time of application as well as long-term instability can adversely impact the efficacy associated with the herbicidal composition.

There thus remains a need for development of stable herbicidal compositions in suspension concentrate formulations, which address the aforementioned challenges and also do not affect the efficacy associated with the herbicidal compositions.

### OBJECTIVES OF THE DISCLOSURE

It is a primary objective of the present disclosure to provide a stable agrochemical composition.

It is another objective of the present disclosure to provide a stable agrochemical composition comprising at least one long-chain fatty acid synthesis inhibitor and at least one phytoene desaturase inhibitor.

It is another objective of the present disclosure to provide a stable agrochemical composition comprising at least one isoxazoline herbicide and at least one phenyl ether herbicide.

It is another objective of the present disclosure to provide a stable agrochemical composition comprising at least one isoxazoline herbicide, at least one phenyl ether herbicide and at least one dispersing agent.

It is another objective of the present disclosure to provide a process for preparation of a stable agrochemical composition comprising at least one isoxazoline herbicide and at least one phenyl ether herbicide.

It is another objective of the present disclosure to provide a method for controlling weeds using the stable agrochemical composition comprising at least one isoxazoline herbicide and at least one phenyl ether herbicide.

### SUMMARY OF THE DISCLOSURE

In one aspect, the present disclosure provides a stable agrochemical composition comprising at least one isoxazoline herbicide and at least one phenyl ether herbicide.

In another aspect, the present disclosure provides a process for preparation of the stable agrochemical composition comprising at least one isoxazoline herbicide and at least one phenyl ether herbicide.

In another aspect, the present disclosure provides a method for controlling weeds, said method comprising applying to the plants or a locus thereof, a stable agrochemical composition comprising at least one isoxazoline herbicide and at least one phenyl ether herbicide.

### DETAILED DESCRIPTION OF THE DISCLOSURE

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

The use of the terms “a”, “an” and “the” and similar referents (especially in the context of the following claims) are to be construed to cover both the singular and the plural, unless otherwise indicated herein or clearly contradicted by context. The terms first, second etc., as used herein are not meant to denote any particular ordering, but simply for convenience to denote a plurality of, for example, layers.

The terms “comprising”, “having”, “including”, and “containing” are to be construed as open-ended terms (i.e., meaning “including, but not limited to”) unless otherwise noted.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

While the disclosure has been described with reference to an exemplary embodiment, it will be understood by those skilled in the art that various changes may be made, and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure is not limited to the particular embodiment disclosed as the best mode contemplated for carrying out this disclosure, but that the disclosure will include all embodiments falling within the scope of the appended claims.

The term “control” relates to a weed, includes control of the weed, as well as protecting a plant, a portion of the plant, or a plant seed from attack or invasion by said weed.

The expression of various quantities in terms of “%” or “% w/v” means the percentage by weight of the total solution or composition unless otherwise specified.

As used herein, the term “agrochemical” refers to all active substances which can be used in the agrochemical field, i.e., fungicides, bactericides, insecticides, acaricides, nematicides, molluscicides, rodenticides, repellents, plant growth regulators, herbicides and safeners, and plant nutrients.

Subsequently, the term “herbicides” encompasses both herbicides as well as plant growth regulators, as far as this does not otherwise emerge from the context. The term ‘herbicide’ as used herein denotes a compound which controls or modifies the growth of undesired weeds/plants.

The term “herbicidally effective amount” indicates the quantity of such a compound or combination of such compounds which is capable of controlling or modifying effect on the growth of harmful plants/undesired vegetation/weeds. Controlling effects include all deviation from natural development, for example: killing, retardation, leaf burn, albinism, dwarfism, etc.

The term “plants” refer to all physical parts of a plant, including seeds, seedlings, saplings, roots, tubers, stems, stalks, foliage and fruits. The term “locus” refers to an area of planted crops or a location where the weeds occur or grows or can occur or grow and is intended to include soil, medium of growth other than soil.

As used herein, the term “pre-emergence” refers to the time point before seedlings emerge from the ground. When any herbicide is applied at pre-emergence stage, it prevents establishment of the germinated weed seedlings.

As used herein, the term “post-emergence” refers to the time point after seedlings emerge from the ground. When any herbicide is applied at post-emergence stage, it prevents growth of the germinated weed seedlings.

While developing a suspension concentrate (SC) comprising an isoxazoline herbicide and a phenyl ether herbicide, it was surprisingly found by the inventors of the present invention that the integrity of suspension concentrate can be maintained using a combination of two dispersing agents. The combination of two dispersing agents in a particular ratio facilitates suspension concentrate formation. The selected combination of the dispersing agents in a selective weight ratio is found to successfully retain the integrity of the actives in the formulation which resulted in greater suspensibility and dispersibility.

Accordingly in an embodiment, the present disclosure provides a stable agrochemical composition.

Accordingly in an embodiment, the present disclosure provides a stable herbicidal composition.

It is another objective of the present disclosure to provide a stable agrochemical composition comprising at least one long-chain fatty acid synthesis inhibitor and at least one phytoene desaturase inhibitor.

In another embodiment, the long chain fatty acid synthesis inhibitor comprises α-chloroacetamides, α-thioacetamides, α-oxyacetamides, oxiranes, isoxazolines, azolyl-carboxamides, benzofuranes, thiocarbamates, or combinations thereof.

In a preferred embodiment, the long chain fatty acid synthesis inhibitor comprises isoxazolines.

In another embodiment, the phytoene desaturase inhibitor comprises phenyl-ethers, n-phenyl heterocycles, diphenyl heterocycles, or combinations thereof.

In a preferred embodiment, the phytoene desaturase inhibitor comprises phenyl-ethers, preferably comprises a phenyl ether.

In another embodiment, the present disclosure provides a stable agrochemical composition comprising at least one isoxazoline herbicide and at least one phenyl ether herbicide.

As used throughout the disclosure, the isoxazoline herbicide or other active ingredients for example the phenyl ether herbicide, include their salts, esters, ethers, polymorphs including solvates and hydrates. A salt includes salts that retain the biological effectiveness and properties of the active ingredient, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods.

In an embodiment, the isoxazoline herbicide is selected from the group comprising pyroxasulfone, fenoxasulfone, or combinations thereof.

According to another embodiment, the isoxazoline herbicide is pyroxasulfone.

In an embodiment, the phenyl ether herbicide is selected from the group comprising diflufenican, flufenican, beflubutamid, beflubutamid-M, picolinafen, or combinations thereof.

According to another embodiment, the phenyl ether herbicide is diflufenican.

According to another embodiment, the phenyl ether herbicide is flufenican.

In an embodiment, the present disclosure provides a stable agrochemical composition comprising at least one isoxazoline herbicide and at least one phenyl ether herbicide, wherein the isoxazoline herbicide is pyroxasulfone.

In an embodiment, the present disclosure provides a stable agrochemical composition comprising at least one isoxazoline herbicide and at least one phenyl ether herbicide, wherein the phenyl ether herbicide is diflufenican.

In an embodiment, the present disclosure provides a stable agrochemical composition comprising at least one isoxazoline herbicide and at least one phenyl ether herbicide, wherein the phenyl ether herbicide is flufenican.

In another embodiment, the present disclosure provides a stable agrochemical composition comprising pyroxasulfone and diflufenican.

In another embodiment, the present disclosure provides a stable agrochemical composition comprising pyroxasulfone and flufenican.

According to an embodiment of the present disclosure, the stable agrochemical composition comprises from about 10% w/v to about 90% w/v of the isoxazoline herbicide, based on total weight of the stable agrochemical composition.

According to an embodiment of the present disclosure, the stable agrochemical composition comprises from about 10% w/v to about 70% w/v of the isoxazoline herbicide, based on total weight of the stable agrochemical composition.

According to an embodiment of the present disclosure, the stable agrochemical composition comprises from about 10% w/v to about 50% w/v of the isoxazoline herbicide, based on total weight of the stable agrochemical composition.

According to an embodiment of the present disclosure, the stable agrochemical composition comprises from about 10% w/v to about 30% w/v of the isoxazoline herbicide, based on total weight of the stable agrochemical composition.

According to an embodiment of the present disclosure, the stable agrochemical composition comprises from about 12% w/v to about 25% w/v of the isoxazoline herbicide, based on total weight of the stable agrochemical composition.

In an embodiment, the present disclosure provides a stable agrochemical composition comprising at least one isoxazoline herbicide and at least one phenyl ether herbicide, wherein the composition comprises from about 12% w/v to about 25% w/v of the isoxazoline herbicide, based on total weight of the stable agrochemical composition.

In an embodiment, the present disclosure provides a stable agrochemical composition comprising at least one isoxazoline herbicide and at least one phenyl ether herbicide, wherein the composition comprises from about 12% w/v to about 25% w/v of pyroxasulfone, based on total weight of the stable agrochemical composition.

In a preferred embodiment, the agrochemical composition comprises from about 16% w/v to about 18% w/v pyroxasulfone based on total weight of the stable agrochemical composition.

According to an embodiment of the present disclosure, the stable agrochemical composition comprises from about 10% w/v to about 90% w/v of the phenyl ether herbicide, based on total weight of the stable agrochemical composition.

According to an embodiment of the present disclosure, the stable agrochemical composition comprises from about 10% w/v to about 70% w/v of the phenyl ether herbicide, based on total weight of the stable agrochemical composition.

According to an embodiment of the present disclosure, the stable agrochemical composition comprises from about 10% w/v to about 50% w/v of the phenyl ether herbicide, based on total weight of the stable agrochemical composition.

According to an embodiment of the present disclosure, the stable agrochemical composition comprises from about 10% w/v to about 30% w/v of the phenyl ether herbicide, based on total weight of the stable agrochemical composition.

According to an embodiment of the present disclosure, the stable agrochemical composition comprises from about 12% w/v to about 30% w/v of the phenyl ether herbicide, based on total weight of the stable agrochemical composition.

In an embodiment, the present disclosure provides a stable agrochemical composition comprising at least one isoxazoline herbicide and at least one phenyl ether herbicide, wherein the composition comprises from about 12% w/v to about 30% w/v of the phenyl ether herbicide, based on total weight of the stable agrochemical composition.

In an embodiment, the present disclosure provides a stable agrochemical composition comprising at least one isoxazoline herbicide and at least one phenyl ether herbicide, wherein the composition comprises from about 12% w/v to about 30% w/v of diflufenican, based on total weight of the stable agrochemical composition.

In an embodiment, the present disclosure provides a stable agrochemical composition comprising at least one isoxazoline herbicide and at least one phenyl ether herbicide, wherein the composition comprises from about 12% w/v to about 30% w/v of flufenican, based on total weight of the stable agrochemical composition.

In a preferred embodiment, the agrochemical composition comprises from about 20% w/v to about 22% w/v diflufenican based on total weight of the stable agrochemical composition.

In a preferred embodiment, the agrochemical composition comprises from about 20% w/v to about 22% w/v flufenican based on total weight of the stable agrochemical composition.

In an embodiment, the present disclosure provides the agrochemical composition comprising from about 12% w/v to about 25% w/v isoxazoline herbicide and from about 12% w/v to about 30% w/v phenyl ether herbicide of total weight of the composition.

In an embodiment, the present disclosure provides a stable agrochemical composition comprising at least one isoxazoline herbicide and at least one phenyl ether herbicide, wherein the composition comprises from about 12% w/v to about 25% w/v of pyroxasulfone and from about 12% w/v to about 30% w/v of diflufenican, based on total weight of the stable agrochemical composition.

In an embodiment, the present disclosure provides a stable agrochemical composition comprising at least one isoxazoline herbicide and at least one phenyl ether herbicide, wherein the composition comprises from about 12% w/v to about 25% w/v of pyroxasulfone and from about 12% w/v to about 30% w/v of flufenican, based on total weight of the stable agrochemical composition.

In a preferred embodiment, the agrochemical composition comprises from about 16% w/v to about 18% w/v pyroxasulfone and from about 20% w/v to about 22% w/v diflufenican based on total weight of the stable agrochemical composition.

In a preferred embodiment, the agrochemical composition comprises from about 16% w/v to about 18% w/v pyroxasulfone and from about 20% w/v to about 22% w/v flufenican based on total weight of the stable agrochemical composition.

According to a preferred embodiment, the present disclosure provides a stable agrochemical composition comprising at least one isoxazoline herbicide, at least one phenyl ether herbicide and dispersing agents.

According to a preferred embodiment, the present disclosure provides a herbicidal composition comprising:
(a) at least one isoxazoline herbicide;
(b) at least one phenyl ether herbicide; and
(c) at least one dispersing agent.

According to a preferred embodiment, the present disclosure provides a stable agrochemical composition comprising at least one isoxazoline herbicide, at least one phenyl ether herbicide and at least one dispersing agent, wherein the isooxazoline herbicide is pyroxasulfone.

According to a preferred embodiment, the present disclosure provides a stable agrochemical composition comprising at least one isoxazoline herbicide, at least one phenyl ether herbicide and at least one dispersing agent, wherein the phenyl ether herbicide is diflufenican.

According to a preferred embodiment, the present disclosure provides a stable agrochemical composition comprising at least one isoxazoline herbicide, at least one phenyl ether herbicide and at least one dispersing agent, wherein the phenyl ether herbicide is flufenican.

According to a preferred embodiment, the present disclosure provides a stable agrochemical composition comprising pyroxasulfone, diflufenican and at least one dispersing agent.

According to a preferred embodiment, the present disclosure provides a stable agrochemical composition comprising pyroxasulfone, flufenican and at least one dispersing agent.

According to an embodiment of the present disclosure, the dispersing agents comprise non-ionic dispersing agents/surfactants. Non-ionic surfactants may be selected from the group comprising fatty acid glycol ester surfactants, polyalkoxylated triglyceride surfactants, alkoxylated fatty alcohol surfactants, and sorbitan fatty acid ester surfactants, polyalkoxylated alkylphenol surfactants, polyalkoxylated alkarylphenol surfactants, amine oxide surfactants, alkanolamide surfactants, glycoside surfactants, fatty alcohol ethoxylate, ethylene oxide/propylene oxide (EO/PO) block copolymers (for example, non-ionic polyalkylene glycol ether, polyalkylene oxide block copolymer, low foaming block copolymers, alkyl EO/PO copolymer, non-ionic EO/PO block copolymer), or combinations thereof.

In a preferred embodiment, the dispersing agent is fatty alcohol ethoxylate.

In a preferred embodiment, the dispersing agent is ethylene oxide/propylene oxide (EO/PO) block copolymer.

In a preferred embodiment, the dispersing agent is selected from fatty alcohol ethoxylate, ethylene oxide/propylene oxide (EO/PO) block copolymer, or combinations thereof.

According to a preferred embodiment, the present disclosure provides a stable agrochemical composition comprising at least one isoxazoline herbicide, at least one phenyl ether herbicide and at least one dispersing agent, wherein the dispersing agent comprise non-ionic dispersing agents.

According to a preferred embodiment, the present disclosure provides a stable agrochemical composition comprising pyroxasulfone, diflufenican and at least one non-ionic dispersing agent.

According to a preferred embodiment, the present disclosure provides a stable agrochemical composition comprising pyroxasulfone, flufenican and at least one non-ionic dispersing agent.

In an embodiment of the present disclosure, the stable agrochemical composition comprises from about 0.1% w/v to about 90% w/v of the non-ionic dispersing agents, based on total weight of the agrochemical composition.

In an embodiment of the present disclosure, the stable agrochemical composition comprises from about 0.1% w/v to about 30% w/v of the non-ionic dispersing agents, based on total weight of the agrochemical composition.

In an embodiment of the present disclosure, the stable agrochemical composition comprises from about 0.1% w/v to about 25% w/v of the non-ionic dispersing agents, based on total weight of the agrochemical composition.

In an embodiment of the present disclosure, the stable agrochemical composition comprises from about 0.1% w/v to about 20% w/v of the non-ionic dispersing agents, based on total weight of the agrochemical composition.

In an embodiment of the present disclosure, the stable agrochemical composition comprises from about 0.1% w/v to about 10% w/v of the non-ionic dispersing agents, based on total weight of the agrochemical composition.

In an embodiment, the present disclosure provides the agrochemical composition comprising from about 0.1% w/v to about 10% w/v dispersing agents of total weight of the composition.

In a preferred embodiment, the agrochemical composition comprises from about 1% w/v to about 3% w/v fatty alcohol ethoxylate based on total weight of the stable agrochemical composition.

In a preferred embodiment, the agrochemical composition comprises from about 2% w/v to about 4% w/v ethylene oxide/propylene oxide (EO/PO) block copolymer based on total weight of the stable agrochemical composition.

In an embodiment, the present disclosure provides a stable agrochemical composition comprising at least one isoxazoline herbicide and at least one phenyl ether herbicide, wherein the composition comprises from about 12% w/v to about 25% w/v of the isoxazoline herbicide, from about 12% w/v to about 30% w/v of the phenyl ether herbicide and from about 0.1% w/v to about 10% w/v of the non-ionic dispersing agents, based on total weight of the stable agrochemical composition.

In an embodiment, the present disclosure provides a stable agrochemical composition comprising at least one isoxazoline herbicide and at least one phenyl ether herbicide, wherein the composition comprises from about 12% w/v to about 25% w/v of pyroxasulfone, from about 12% w/v to about 30% w/v of diflufenican and from about 0.1% w/v to about 10% w/v of the non-ionic dispersing agents, based on total weight of the stable agrochemical composition.

In an embodiment, the present disclosure provides a stable agrochemical composition comprising at least one isoxazoline herbicide and at least one phenyl ether herbicide, wherein the composition comprises from about 12% w/v to about 25% w/v of pyroxasulfone, from about 12% w/v to about 30% w/v of flufenican and from about 0.1% w/v to about 10% w/v of the non-ionic dispersing agents, based on total weight of the stable agrochemical composition.

According to an embodiment of the present disclosure, a stable agrochemical composition comprising at least one isoxazoline herbicide, at least one phenyl ether herbicide and at least one dispersing agent, wherein the dispersing agents are present in a weight ratio ranging from about 0.5:100 to about 100:0.5, preferably from about 1:100 to about 100:1, preferably from about 1:90 to about 90:1, preferably from about 1:80 to about 80:1, preferably from about 1:70 to about 70:1, preferably from about 1:60 to about 60:1, preferably from about 1:50 to about 50:1, preferably from about 1:40 to about 40:1, preferably from about 1:30 to about 30:1, preferably from about 1:20 to about 20:1, preferably from about 1:10 to about 10:1.

According to an embodiment of the present disclosure, a stable agrochemical composition comprising at least one isoxazoline herbicide, at least one phenyl ether herbicide and at least one dispersing agent, wherein the dispersing agents are present in a weight ratio ranging from about 0.5:10 to about 10:0.5.

According to an embodiment of the present disclosure, a stable agrochemical composition comprising pyroxasulfone, diflufenican and at least one dispersing agent, wherein the dispersing agents are present in a weight ratio ranging from about 0.5:10 to about 10:0.5.

According to an embodiment of the present disclosure, a stable agrochemical composition comprising pyroxasulfone, flufenican and at least one dispersing agent, wherein the dispersing agents are present in a weight ratio ranging from about 0.5:10 to about 10:0.5.

According to an embodiment of the present disclosure, a stable agrochemical composition comprising at least one isoxazoline herbicide, at least one phenyl ether herbicide and at least one non-ionic dispersing agent, wherein the non-ionic dispersing agents are present in a weight ratio ranging from about 0.5:10 to about 10:0.5.

According to an embodiment of the present disclosure, a stable agrochemical composition comprising pyroxasulfone, diflufenican and at least one non-ionic dispersing agent, wherein the non-ionic dispersing agents are present in a weight ratio ranging from about 0.5:10 to about 10:0.5.

According to an embodiment of the present disclosure, a stable agrochemical composition comprising pyroxasulfone, flufenican and at least one non-ionic dispersing agent, wherein the non-ionic dispersing agents are present in a weight ratio ranging from about 0.5:10 to about 10:0.5.

According to an embodiment of the present disclosure, a stable agrochemical composition comprising at least one isoxazoline herbicide, at least one phenyl ether herbicide and two dispersing agents, wherein the two dispersing agents are present in a weight ratio ranging from about 0.5:10 to about 10:0.5.

According to an embodiment of the present disclosure, a stable agrochemical composition comprising pyroxasulfone, diflufenican and two dispersing agents, wherein the two dispersing agents are present in a weight ratio ranging from about 0.5:10 to about 10:0.5.

According to an embodiment of the present disclosure, a stable agrochemical composition comprising pyroxasulfone, flufenican and two dispersing agents, wherein the two dispersing agents are present in a weight ratio ranging from about 0.5:10 to about 10:0.5.

According to an embodiment of the present disclosure, a stable agrochemical composition comprising at least one isoxazoline herbicide, at least one phenyl ether herbicide and two non-ionic dispersing agents, wherein the two non-ionic dispersing agents are present in a weight ratio ranging from about 0.5:10 to about 10:0.5.

According to an embodiment of the present disclosure, a stable agrochemical composition comprising pyroxasulfone, diflufenican and two non-ionic dispersing agents, wherein the two non-ionic dispersing agents are present in a weight ratio ranging from about 0.5:10 to about 10:0.5.

According to an embodiment of the present disclosure, a stable agrochemical composition comprising pyroxasulfone, flufenican and two non-ionic dispersing agents, wherein the two non-ionic dispersing agents are present in a weight ratio ranging from about 0.5:10 to about 10:0.5.

In a preferred embodiment, the fatty alcohol ethoxylate and the ethylene oxide/propylene oxide block copolymer are present in a weight ratio ranging from about 0.5:10 to about 10:0.5.

In a preferred embodiment, the fatty alcohol ethoxylate and the ethylene oxide/propylene oxide block copolymer are present in a weight ratio of about 1:1.33.

In a preferred embodiment, the fatty alcohol ethoxylate and the ethylene oxide/propylene oxide block copolymer are present in a weight ratio of about 1:1.5.

In a preferred embodiment, the fatty alcohol ethoxylate and the ethylene oxide/propylene oxide block copolymer are present in a weight ratio of about 1:2. Unless otherwise indicated, the ratios disclosed throughout the specification are weight ratios.

According to an embodiment of the present disclosure, a stable agrochemical composition comprising at least one isoxazoline herbicide, at least one phenyl ether herbicide and at least one dispersing agent, wherein the isoxazoline herbicide and the phenyl ether herbicide are present in a weight ratio of about 1:10 to about 10:1.

According to an embodiment of the present disclosure, a stable agrochemical composition comprising at least one isoxazoline herbicide, at least one phenyl ether herbicide and at least one non-ionic dispersing agent, wherein the isoxazoline herbicide and the phenyl ether herbicide are present in a weight ratio of about 1:10 to about 10:1.

According to an embodiment of the present disclosure, a stable agrochemical composition comprising at least one isoxazoline herbicide, at least one phenyl ether herbicide and two non-ionic dispersing agents, wherein the isoxazoline herbicide and the phenyl ether herbicide are present in a weight ratio from about 1:10 to about 10:1.

According to an embodiment of the disclosure, the stable agrochemical composition comprises pyroxasulfone, diflufenican, and at least one dispersing agent, wherein pyroxasulfone and diflufenican are present in a weight ratio of about 1:10 to about 10:1.

According to an embodiment of the disclosure, the stable agrochemical composition comprises pyroxasulfone, diflufenican, and at least one non-ionic dispersing agent, wherein pyroxasulfone and diflufenican are present in a weight ratio of about 1:10 to about 10:1.

According to an embodiment of the disclosure, the stable agrochemical composition comprises pyroxasulfone, diflufenican, and two non-ionic dispersing agents, wherein pyroxasulfone and diflufenican are present in a weight ratio of about 1:10 to about 10:1.

According to an embodiment of the disclosure, the stable agrochemical composition comprises pyroxasulfone, flufenican, and at least one dispersing agent, wherein pyroxasulfone and flufenican are present in a weight ratio of about 1:10 to about 10:1.

According to an embodiment of the disclosure, the stable agrochemical composition comprises pyroxasulfone, flufenican, and at least one non-ionic dispersing agent, wherein pyroxasulfone and flufenican are present in a weight ratio of about 1:10 to about 10:1.

According to an embodiment of the disclosure, the stable agrochemical composition comprises pyroxasulfone, flufenican, and two non-ionic dispersing agents, wherein pyroxasulfone and flufenican are present in a weight ratio of about 1:10 to about 10:1.

According to an embodiment of the disclosure, the stable agrochemical composition comprises pyroxasulfone, diflufenican, and at least one dispersing agent, wherein pyroxasulfone and diflufenican are present in a weight ratio of about 1:5 to about 5:1.

According to an embodiment of the disclosure, the stable agrochemical composition comprises pyroxasulfone, diflufenican, and at least one non-ionic dispersing agent, wherein pyroxasulfone and diflufenican are present in a weight ratio of about 1:5 to about 5:1.

According to an embodiment of the disclosure, the stable agrochemical composition comprises pyroxasulfone, diflufenican, and two non-ionic dispersing agents, wherein pyroxasulfone and diflufenican are present in a weight ratio of about 1:5 to about 5:1.

According to an embodiment of the disclosure, the stable agrochemical composition comprises pyroxasulfone, flufenican, and at least one dispersing agent, wherein pyroxasulfone and flufenican are present in a weight ratio of about 1:5 to about 5:1.

According to an embodiment of the disclosure, the stable agrochemical composition comprises pyroxasulfone, flufenican, and at least one non-ionic dispersing agent, wherein pyroxasulfone and flufenican are present in a weight ratio of about 1:5 to about 5:1.

According to an embodiment of the disclosure, the stable agrochemical composition comprises pyroxasulfone, flufenican, and two non-ionic dispersing agents, wherein pyroxasulfone and flufenican are present in a weight ratio of about 1:5 to about 5:1.

According to an embodiment of the disclosure, the stable agrochemical composition comprises pyroxasulfone, diflufenican, and at least one dispersing agent, wherein pyroxasulfone and diflufenican are present in a weight ratio of about 1:1.3 to about 1.3:1.

According to an embodiment of the disclosure, the stable agrochemical composition comprises pyroxasulfone, diflufenican, and at least one non-ionic dispersing agent, wherein pyroxasulfone and diflufenican are present in a weight ratio of about 1:1.3 to about 1.3:1.

According to an embodiment of the disclosure, the stable agrochemical composition comprises pyroxasulfone, diflufenican, and two non-ionic dispersing agents, wherein pyroxasulfone and diflufenican are present in a weight ratio of about 1:1.3 to about 1.3:1.

According to an embodiment of the disclosure, the stable agrochemical composition comprises pyroxasulfone, flufenican, and at least one dispersing agent, wherein pyroxasulfone and flufenican are present in a weight ratio of about 1:1.3 to about 1.3:1.

According to an embodiment of the disclosure, the stable agrochemical composition comprises pyroxasulfone, flufenican, and at least one non-ionic dispersing agent, wherein pyroxasulfone and flufenican are present in a weight ratio of about 1:1.3 to about 1.3:1.

According to an embodiment of the disclosure, the stable agrochemical composition comprises pyroxasulfone, flufenican, and two non-ionic dispersing agents, wherein pyroxasulfone and flufenican are present in a weight ratio of about 1:1.3 to about 1.3:1.

The composition described above is active in controlling weeds and is stable. It has been found that at least one dispersing agent in a particular ratio in the agrochemical composition of the present invention provides excellent stability over time and at various temperatures. The present agrochemical composition obtained has a superior suspensibility, better dispersibility and no sedimentation.

According to a preferred embodiment, the present disclosure provides a stable agrochemical composition comprising at least one isoxazoline herbicide, at least one phenyl ether herbicide, at least one dispersing agent, and at least one agrochemically acceptable excipient.

According to a preferred embodiment, the present disclosure provides a stable agrochemical composition comprising pyroxasulfone, diflufenican, at least one dispersing agent and at least one agrochemically acceptable excipient.

According to a preferred embodiment, the present disclosure provides a stable agrochemical composition comprising pyroxasulfone, flufenican, at least one dispersing agent and at least one agrochemically acceptable excipient.

In another embodiment, the present disclosure provides a herbicidal composition comprising:
(a) at least one isoxazoline herbicide;
(b) at least one phenyl ether herbicide;
(c) at least one dispersing agent; and
(d) at least one agrochemically acceptable excipient.

According to an embodiment of the present disclosure, the agrochemically acceptable excipient is selected from the group comprising emulsifier(s), colorant(s), thickener(s)/binder(s), antifreeze agent(s), antifoaming agent(s), antioxidant(s), solvent(s), preservative(s), glidant(s), anticaking agent(s), pH-regulating agent(s), buffering agent(s), formulation aid(s), disintegrant(s), or combinations thereof.

In another embodiment, emulsifier(s) which can be advantageously employed herein can be readily determined by those skilled in the art and include various non-ionic, anionic, cationic, and amphoteric emulsifiers, or a blend of two or more emulsifiers. Examples of non-ionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers, appropriate salts of phosphated polyglycol ether, or combinations thereof.

In an embodiment, colorant(s) may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc, or combinations thereof.

In an embodiment, thickener(s) or gelling agent(s) may be selected from but not limited to molasses, granulated sugar, alginates, karaya gum, jaguar gum, tragacanth gum, polysaccharide gum, mucilage, xanthan gum, or combinations thereof.

In another embodiment, the binder(s) may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols, or combinations thereof.

In another embodiment, antifreeze agent(s) added to the composition may be alcohols selected from the group comprising but not limited to ethylene glycol, propylene glycol, 1,2-propylene glycol, 1,3-propylene glycol, 1,2-propylenediol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol, or combinations thereof.

According to an embodiment, antifoam agent(s) may be selected from silicone defoamers, polydimethoxysiloxane, polydimethylsiloxane, alkyl poly acrylates, castor oil, fatty acids, fatty acids esters, fatty acids sulfate, fatty alcohol, fatty alcohol esters, fatty alcohol sulfate, foot olive oil, mono & di glyceride, paraffin oil, paraffin wax, poly propylene glycol, silicones oil, vegetable fats, vegetable fats sulfate, vegetable oil, vegetable oil sulfate, vegetable wax, vegetable wax sulfate, agents based on silicon or magnesium stearate, or combinations thereof.

The agrochemical composition may also comprise one or more antioxidant(s). Preferably, the agrochemical formulation comprises an antioxidant. Antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., α-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., α-hydroxy fatty acids, EDTA, EGTA, phytic acid, lactoferrin), α-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., γ-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide). According to the disclosure, suitable derivatives (salts, esters, sugars, nucleotides, nucleosides, peptides, and lipids) and mixtures of these specified active ingredients or plant extracts (e.g., teatree oil, rosemary extract and rosemarinic acid) which comprise these antioxidants can be used. In general, mixtures of the aforementioned antioxidants are possible.

According to an embodiment, examples of suitable solvent(s)/inert carrier(s) are water, oils of vegetable, or derivatives. In principle, solvent mixtures may also be used.

In another embodiment, suitable preservative(s)/biocide(s) are for example benzothiazoles, 1,2-benzisothiazolin-3-one, 1,2-benzisothiozolin-3-one, sodium dichloro-s-triazinetrione, sodium benzoate, potassium sorbate, 1,2-phenyl-isothiazolin-3-one, inter chloroxylenol paraoxybenzoate butyl and benzoic acid, or combinations thereof.

In another embodiment, the agrochemical composition comprises from about 0.1% w/v to about 30% w/v agrochemically acceptable excipient based on total weight of the stable agrochemical composition.

According to an embodiment, the present disclosure provides a stable agrochemical composition comprising at least one isoxazoline herbicide, at least one phenyl ether herbicide and at least one dispersing agent, wherein the stable agrochemical composition is present in a form of a liquid formulation.

In an embodiment, the stable agrochemical composition is selected from capsule suspension (CS), dispersible concentrate (DC), emulsion, water in oil (EO), emulsion, oil in water (EW), oil dispersion (OD), oil miscible flowable concentrate (oil miscible suspension (OF), oil miscible liquid (OL), suspension concentrate (SC), suspo-emulsion (SE), or combinations thereof.

According to an embodiment, the stable agrochemical composition is present in a form of a suspension concentrate (SC).

In another embodiment, the suspension concentrate comprises:
(a) pyroxasulfone;
(b) diflufenican;
(c) fatty alcohol ethoxylate;
(d) ethylene oxide/propylene oxide block copolymer; and
(e) at least one agrochemically acceptable excipient.

In another embodiment, the suspension concentrate comprises:
(a) pyroxasulfone;
(b) flufenican;
(c) fatty alcohol ethoxylate;
(d) ethylene oxide/propylene oxide block copolymer; and
(e) at least one agrochemically acceptable excipient.

In an embodiment, the present invention provides a suspension concentrate comprising at least one isoxazoline herbicide, at least one phenyl ether herbicide and at least one dispersing agent.

In an embodiment, the present invention provides a suspension concentrate comprising pyroxasulfone, diflufenican and at least one dispersing agent.

In an embodiment, the present invention provides a suspension concentrate comprising pyroxasulfone, flufenican and at least one dispersing agent.

In an embodiment, the present invention provides a suspension concentrate comprising at least one isoxazoline herbicide, at least one phenyl ether herbicide and at least one dispersing agent, either in the form of a tank mix or a pre-formulated (pre-mix) formulation.

In an embodiment, the present invention provides a suspension concentrate comprising at least one isoxazoline herbicide, at least one phenyl ether herbicide and at least one dispersing agent, in the form of a pre-formulated (pre-mix) formulation.

In an embodiment, the present invention provides a pre-mix formulation comprising pyroxasulfone and diflufenican.

In an embodiment, the present invention provides a pre-mix formulation comprising pyroxasulfone and flufenican.

In another aspect, the present disclosure provides a process for the preparation of the present stable agrochemical composition, wherein the stable agrochemical composition comprises at least one isoxazoline herbicide, at least one phenyl ether herbicide and at least one dispersing agent.

In another aspect, the present disclosure provides a process for the preparation of the present stable agrochemical composition, the process comprising:
(a) adding a solvent along with at least one dispersing agent and at least one agrochemically acceptable excipient to form a mixture and homogenizing the mixture;
(b) adding at least one isoxazoline herbicide and at least one phenyl ether herbicide to the mixture and homogenizing the mixture to form a uniform slurry; and
(c) milling the slurry at a temperature from about 15° C. to about 35° C. to get required particle size and collecting it in a gelling vessel to obtain a stable agrochemical composition.

In another embodiment, the process for preparing the herbicidal composition comprises:
(a) adding a solvent along with at least one dispersing agent and at least one agrochemically acceptable excipient to form a mixture and homogenizing the mixture;
(b) adding at least one isoxazoline herbicide and at least one phenyl ether herbicide to the mixture and homogenizing the mixture to form a uniform slurry; and
(c) milling the slurry at a temperature from about 15° C. to about 35° C. to get required particle size and collecting it in a gelling vessel to obtain a herbicidal composition.

In another embodiment, the process for preparing the herbicidal composition comprises:
(a) adding a solvent along with at least one dispersing agent and at least one agrochemically acceptable excipient to form a mixture and homogenizing the mixture;
(b) adding pyroxasulfone and diflufenican to the mixture and homogenizing the mixture to form a uniform slurry; and
(c) milling the slurry at a temperature from about 15° C. to about 35° C. to get required particle size and collecting it in a gelling vessel to obtain a herbicidal composition.

In an embodiment, the step (c) comprises adding a gelling agent to the gelling vessel to obtain the required viscosity of the agrochemical composition.

In an embodiment, the slurry is milled at a temperature range from about 15° C. to about 35° C. to achieve the required particle size.

According to an embodiment, the agrochemical composition has a particle size distribution (D₅₀) ranging from about 3 to about 5 microns.

According to an embodiment, the agrochemical composition has a particle size distribution (D₅₀) of about 3 microns.

According to an embodiment, the agrochemical composition has a particle size distribution (D₅₀) of about 4 microns.

According to an embodiment, the agrochemical composition has a particle size distribution (D₅₀) of about 5 microns.

According to an embodiment, the agrochemical composition has a particle size distribution (D₉₀) ranging from about 10 to about 25 microns.

According to an embodiment, the agrochemical composition has a particle size distribution (D₉₀) of less than about 12 microns.

According to an embodiment, the agrochemical composition has a particle size distribution (D₉₀) of about 12 microns.

According to an embodiment, the agrochemical composition has a particle size distribution (D₉₀) of less than about 25 microns.

According to an embodiment, the agrochemical composition has a particle size distribution (D₉₉) of about 25 microns.

In another embodiment, the present disclosure provides use of the present stable agrochemical composition for controlling weeds, wherein the stable agrochemical composition comprises at least one isoxazoline herbicide and at least one phenyl ether herbicide.

In another embodiment, the present disclosure provides use of the present stable agrochemical composition for controlling weeds, wherein the stable agrochemical composition comprises at least one isoxazoline herbicide, at least one phenyl ether herbicide and at least one dispersing agent.

In another aspect, the present disclosure provides a method for controlling weeds, said method comprising applying to the plants or locus thereof an agrochemical composition comprising at least one isoxazoline herbicide and at least one phenyl ether herbicide.

In another aspect, the present disclosure provides a method for controlling weeds, said method comprising applying to the plants or locus thereof an agrochemical composition comprising at least one isoxazoline herbicide, at least one phenyl ether herbicide and at least one dispersing agent.

In a preferred embodiment, the present disclosure provides use of a herbicidal composition for controlling weeds, the composition comprising:
(a) at least one isoxazoline herbicide;
(b) at least one phenyl ether herbicide;
(c) at least one dispersing agent; and
(d) at least one agrochemically acceptable excipient.

In a preferred embodiment, the present disclosure provides use of a herbicidal composition for controlling weeds, the composition comprising:
(a) pyroxasulfone;
(b) diflufenican;
(c) fatty alcohol ethoxylate;
(d) ethylene oxide/propylene oxide block copolymer; and
(e) at least one agrochemically acceptable excipient.

In another embodiment, the composition of the present disclosure is used to control weeds in various agricultural crops. Non-limiting examples of weeds controlled by the composition of the present disclosure include:
Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus, or combinations thereof.

Non-limiting examples of weeds controlled by the composition of the present disclosure include:
Poaceae weeds: Dinebra retroflexa, Cynodon dactylon, Echinochloa colonum, Echinochloa crusgalli, Setaria viridis, Setaria faberi, Setaria glauca, Setaria ilosa ate, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spicaventi, Panicum dichotomiflorum, Panicum texanum, Panicum maximum, Brachiaria reptains Brachiaria platyphylla, Brachiaria ruziziensis, Brachiaria plantaginea, Brachiaria decumbens, Brachiaria brizantha, Brachiaria humidicola, Brachiaria mutica, Cenchrus echinatus, Cenchrus pauciflorus, Eriochloa villosa, Pennisetum setosum, Chloris gayana, Chloris barbata, Eragrostis ilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis, or combinations thereof.

In another embodiment, the composition of the present disclosure is used to control weeds in various agricultural crops.

In another embodiment, the various (target) agricultural crops include, but not limited to, corn, rice, wheat, barley, rye, oat, Sorghum, cotton, soybean, peanut, buckwheat, beet, rapeseed, sunflower, sugar cane, tobacco, etc.;

### Vegetables:

Solanaceous vegetables such as eggplant, tomato, pimento, pepper, potato, etc., cucurbit vegetables such as cucumber, pumpkin, zucchini, watermelon, melon, squash, etc.,
Cruciferous vegetables such as radish, white turnip, horseradish, kohlrabi, Chinese cabbage, cabbage, leaf mustard, broccoli, cauliflower, etc.,
Asteraceous vegetables such as burdock, crown daisy, artichoke, lettuce, etc, Liliaceous vegetables such as green onion, onion, garlic, and asparagus, Ammiaceous vegetables such as carrot, parsley, celery, parsnip, etc.,
Chenopodiaceous vegetables such as spinach, Swiss chard, etc.,
Lamiaceous vegetables such as Perilla frutescens, mint, basil, etc, strawberry, sweet potato, Dioscorea japonica, colocasia, etc., flowers, foliage plants, turf grasses,

### Fruits:

Pome fruits such apple, pear, quince, etc, stone fleshy fruits such as peach, plum, nectarine, Prunus mume, cherry fruit, apricot, prune, etc.,
Citrus fruits such as orange, lemon, rime, grapefruit, etc.,
Nuts such as chestnuts, walnuts, hazelnuts, almond, pistachio, cashew nuts, macadamia nuts, etc.
Berries such as blueberry, cranberry, blackberry, raspberry, etc., grape, kaki fruit, olive, plum, banana, coffee, date palm, coconuts, etc;
Trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc., or combinations thereof.

In another embodiment, the present disclosure provides a method for using the present stable agrochemical composition for controlling weeds, wherein the stable agrochemical composition comprises at least one isoxazoline herbicide, at least one phenyl ether herbicide and at least one dispersing agent.

In a preferred embodiment, the present disclosure provides a method for controlling weeds by applying an effective amount of a herbicidal composition to a plant or a locus thereof, the composition comprising:
(a) at least one isoxazoline herbicide;
(b) at least one phenyl ether herbicide;
(c) at least one dispersing agent; and
(d) at least one agrochemically acceptable excipient.

In a preferred embodiment, the present disclosure provides a method for controlling weeds by applying an effective amount of a herbicidal composition to a plant or a locus thereof, the composition comprising:
(a) pyroxasulfone;
(b) diflufenican;
(c) fatty alcohol ethoxylate;
(d) ethylene oxide/propylene oxide block copolymer; and
(e) at least one agrochemically acceptable excipient.

In another embodiment, the present disclosure provides a method for using the present stable agrochemical composition for controlling weeds, wherein the stable agrochemical composition comprises at least one isoxazoline herbicide, at least one phenyl ether herbicide and at least one dispersing agent, wherein the isooxazoline herbicide is applied at a rate from about 50 g a.i./ha to about 250 g a.i./ha.

In another embodiment, the present disclosure provides a method for using the present stable agrochemical composition for controlling weeds, wherein the stable agrochemical composition comprises at least one isoxazoline herbicide, at least one phenyl ether herbicide and at least one dispersing agent, wherein pyroxasulfone is applied at a rate from about 50 g a.i./ha to about 250 g a.i./ha.

In another embodiment, the present disclosure provides a method for using the present stable agrochemical composition for controlling weeds, wherein the stable agrochemical composition comprises at least one isoxazoline herbicide, at least one phenyl ether herbicide and at least one dispersing agent, wherein pyroxasulfone is applied at a rate of about 100 g a.i./ha.

In another embodiment, the present disclosure provides a method for using the present stable agrochemical composition for controlling weeds, wherein the stable agrochemical composition comprises at least one isoxazoline herbicide, at least one phenyl ether herbicide and at least one dispersing agent, wherein the phenyl ether herbicide is applied at a rate from about 50 g a.i./ha to about 350 g a.i./ha.

In another embodiment, the present disclosure provides a method for using the present stable agrochemical composition for controlling weeds, wherein the stable agrochemical composition comprises at least one isoxazoline herbicide, at least one phenyl ether herbicide and at least one dispersing agent, wherein diflufenican herbicide is applied at a rate from about 50 g a.i./ha to about 350 g a.i./ha.

In another embodiment, the present disclosure provides a method for using the present stable agrochemical composition for controlling weeds, wherein the stable agrochemical composition comprises at least one isoxazoline herbicide, at least one phenyl ether herbicide and at least one dispersing agent, wherein diflufenican herbicide is applied at a rate of about 75 g a.i./ha.

In another embodiment, the present disclosure provides a method for using the present stable agrochemical composition for controlling weeds, wherein the stable agrochemical composition comprises at least one isoxazoline herbicide, at least one phenyl ether herbicide and at least one dispersing agent, wherein diflufenican herbicide is applied at a rate of about 125 g a.i./ha.

In another embodiment, the present disclosure provides a method for using the present stable agrochemical composition for controlling weeds, wherein the stable agrochemical composition comprises at least one isoxazoline herbicide, at least one phenyl ether herbicide and at least one dispersing agent, wherein flufenican herbicide is applied at a rate from about 50 g a.i./ha to about 350 g a.i./ha.

In another embodiment, the present disclosure provides a method for using the present stable agrochemical composition for controlling weeds, wherein the stable agrochemical composition comprises at least one isoxazoline herbicide, at least one phenyl ether herbicide and at least one dispersing agent, wherein flufenican herbicide is applied at a rate of about 75 g a.i./ha.

In another embodiment, the present disclosure provides a method for using the present stable agrochemical composition for controlling weeds, wherein the stable agrochemical composition comprises at least one isoxazoline herbicide, at least one phenyl ether herbicide and at least one dispersing agent, wherein flufenican herbicide is applied at a rate of about 125 g a.i./ha.

In an embodiment, the present method for controlling weeds comprises applying a pre-mix formulation of pyroxasulfone and diflufenican.

In an embodiment, the present method for controlling weeds comprises applying a pre-mix formulation of pyroxasulfone and flufenican.

In an embodiment the pre-mix formulation is in the form of suspension concentrate (SC).

According to an embodiment of the present disclosure, the various components of the agrochemical composition can be used individually or already partially or completely mixed with one at least one other to prepare the composition according to the disclosure. It is also possible for them to be packaged and used further as composition such as a kit of parts.

According to an embodiment of the present disclosure, there is provided a kit comprising:
at least one isoxazoline herbicide;
at least one phenyl ether herbicide;
at least one dispersing agent; and
at least one agrochemically acceptable excipient;
and optionally further comprises:
instructions for use.

According to an embodiment of the present disclosure, there is provided a kit comprising pyroxasulfone, diflufenican and at least one dispersing agent.

According to an embodiment of the present disclosure, there is provided a kit comprising pyroxasulfone, flufenican and at least one dispersing agent.

In one embodiment of the disclosure, the kits may include one or more, including all, components that may be used to prepare the agrochemical concentrate composition, e.g., kits may include active ingredients and/or dispersing agents. One or more of the components may already be combined together or pre-formulated. In those embodiments where more than two components are provided in a kit, the components may already be combined together and as such are packaged in a single container such as a vial, bottle, can, pouch, bag or canister.

It will be understood that the specification and examples are illustrative but not limiting of the present disclosure and that other embodiments within the spirit and scope of the disclosure will suggest themselves to those skilled in the art. Other embodiments can be practiced that are also within the scope of the present disclosure.

In another embodiment, alternative or multiple embodiments of the disclosure disclosed herein are not to be construed as limitations. Each embodiment can be referred to and claimed individually or in any combination with other embodiments of the disclosure. One or more embodiments of the disclosure can be included in, or deleted from, the disclosure for reasons of convenience and/or patentability.

The disclosure will now be described in more details with reference to the following examples. While the foregoing written description of the disclosure enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiment, method, and following examples, but by all embodiments and methods within the scope and spirit of the disclosure.

### EXAMPLES

### Example 1: Suspension Concentrate (SC) Formulation

The agrochemical composition of the present invention was formulated as a suspension concentrate (SC) formulation.

| Ingredients | Quantity (% w/v) |
|---|---|
| Diflufenican | 20-22 |
| Pyroxasulfone | 16-18 |
| Fatty alcohol ethoxylate | 1-3 |
| EO/PO Block copolymer | 2-4 |
| surfactant | |
| Propylene glycol | 3-7 |
| Xanthan Gum | 0.1-0.17 |
| 1,2-benzisothiozolin-3-one | 0.1-0.15 |
| Silicone defoamer | 0.2 to 1.0 |
| Water | Q.S. |
| Total | 100 |

### Process:

DM water was mixed with fatty alcohol ethoxylate, EQ/PG block copolymer, 1,2 benzisothiozolin-3-one and silicone defoamer to form a homogenous mixture. Diflufenican and pyroxasulfone were added to the mixture and homogenized further to form a uniform slurry. The slurry was charged to a suitable type of wet mill and milled at a temperature range from about 15° C. to about 35° C. The process of milling was continued till the desired particle size (D₅₀: 3 to 5 microns) was achieved and the slurry was then charged to a gelling vessel, further adding gelling agent to it. The obtained slurry was slowly stirred to get the desired viscosity of the agrochemical composition.

### Example 2: Stability Study Data

A stability study of the present composition was performed at ambient as well as accelerated heat conditions and the results are tabulated in Table 1.

TABLE 1
Stability study data

| | | | Ambient | AHS-14 |
|---|---|---|---|---|
| Sr. No. | Parameters | Specification | Temperature | Days |
| 1 | Appearance | White to off- | White coloured suspension | |
| | | white coloured | free from any visible | |
| | | suspension free | extraneous matter | |
| | | from any visible | | |
| | | extraneous | | |
| | | matter | | |
| 2 | Active Content (g/L) | | | |
| | 1. Diflufenican | 235-265 g/L | 261.5 | 263.7 |
| | 2. Pyroxasulfone | 188-212 g/L | 211.3 | 211.7 |
| 3 | Suspensibility | 70.0 (Minimum) | 98.05 | 92.67 |
| | (%, gravimetric) | | | |
| 4 | pH (1% aqueous | 5.0-8.0 | 7.10 | 6.80 |
| | suspension) | | | |
| 5 | Specific | 1.18 ± 0.02 | 1.1882 | 1.1879 |
| | gravity @20° C. | | | |
| 6 | Persistence Foam | Maximum 60 | Nil | Nil |
| | | mL Foam in | | |
| | | Water D after | | |
| | | 1 minute | | |
| 7 | Wet Sieve passing | Minimum 98% w/w | Complies | Complies |
| | through 200 BSS | of formulation | | |
| | test sieve (% w/w) | should pass | | |
| | | through 75- | | |
| | | micron sieve | | |
| 8 | Particle Size | D-50: 3-5 microns | 3.88 | 4.05 |
| | Distribution (PSD) | D-90 <12 microns | 8.62 | 10.4 |
| | | D-99 <25 microns | 17.37 | 17.7 |
| 9 | Stability | Sample should | Complies | NA |
| | at 0° C. | comply to Wet | | |
| | | Sieve Test, after | | |
| | | storage at 0° C. | | |
| | | for 7 days | | |
| 10 | Spontaneity of | Minimum 80% | 89.22 | 87.57 |
| | Dispersion | w/w of a.i.in | | |
| | (% a.i.) | suspension after | | |
| | | 5 min. water D | | |
| | | at 30 ± 2° C. | | |

NA = not applicable
ND—not determined

The composition of the present invention was evaluated for various physicochemical parameters. It was observed that the composition comprising diflufenican and pyroxasulfone resulted into >90% suspensibility at ambient as well as AHS temperatures.

### Example 3: Bio-Efficacy Study

The bio-efficacy of the present composition comprising pyroxasulfone and diflufenican was tested and the performance was recorded in the below table. A study was conducted to assess the efficacy of pyroxasulfone and diflufenican for percentage control of Avena fatua spp. The results have been tabulated in Table 2.

TABLE 2
Bio-efficacy study data

| | | Avena fatua % | Avena fatua |
|---|---|---|---|
| | | control | count/m² |
| Component | Rate/ha | 84 DAA | 106 DAA |
| Pyroxasulfone + | 100.3 g a.i./ha + | 95 | 0.2 |
| Diflufenican | 75 g a.i./ha | | |
| Pyroxasulfone + | 100.3 g a.i./ha + | 100 | 0.1 |
| Diflufenican | 125 g a.i./ha | | |

DAA = days after application

It was observed that pyroxasulfone and diflufenican showed efficacy up to 84 DAA.

### Example 4: Bio-Efficacy Study

A study was conducted to assess the efficacy of pyroxasulfone and diflufenican for percentage control of Lolium spp. and Raphanus spp. in wheat crop. The results have been tabulated in Table 3.

TABLE 3
Percentage control of Lolium spp. and Raphanus spp.

| | | | | |
|---|---|---|---|---|
| Component | Rate/ha | 35 DAA | 41 DAA | 60 DAA |

Lolium spp. % control in wheat

| | | | | |
|---|---|---|---|---|
| Untreated | — | 0 | 0 | 0 |
| Pyroxasulfone + | 100 g/ha + | 82.5 | 77.5 | 80 |
| Diflufenican | 125 g/ha | | | |

Raphanus spp. % control in wheat

| | | | | |
|---|---|---|---|---|
| Untreated | — | 0 | 0 | 0 |
| Pyroxasulfone + | 100 g/ha + | 78.8 | 87.5 | 83.8 |
| Diflufenican | 125 g/ha | | | |

DAA = days after application

It was observed that pyroxasulfone and diflufenican showed efficacy up to 60 DAA.

1. A herbicidal composition comprising:
(a) at least one isoxazoline herbicide;
(b) at least one phenyl ether herbicide;
(c) at least one dispersing agent; and
(d) at least one agrochemically acceptable excipient.

2. The composition as claimed in claim 1, wherein the isoxazoline herbicide is selected from the group comprising pyroxasulfone, fenoxasulfone, or combinations thereof.

3. The composition as claimed in claim 1, wherein the phenyl ether herbicide is selected from the group comprising diflufenican, flufenican, beflubutamid, beflubutamid-M, picolinafen, or combinations thereof.

4. The composition as claimed in claim 1, wherein the dispersing agent is selected from fatty alcohol ethoxylate, ethylene oxide/propylene oxide block copolymer, or combinations thereof.

5. The composition as claimed in claim 1, wherein the isoxazoline herbicide and the phenyl ether herbicide are present in a weight ratio from about 1:10 to about 10:1.

6. The composition as claimed in claim 1, wherein the dispersing agents are present in a weight ratio from about 0.5:10 to about 10:0.5.

7. The composition as claimed in claim 1, wherein the agrochemically acceptable excipient is selected from the group comprising emulsifiers, colorants, thickeners/binders, antifreeze agents, antifoaming agents, antioxidants, solvents, preservatives, glidants, anticaking agents, pH-regulating agents, buffering agents, formulation aids, disintegrants, or combinations thereof.

8. The composition as claimed in claim 1, wherein the composition comprises from about 12% w/v to about 25% w/v isoxazoline herbicide and from about 12% w/v to about 30% w/v phenyl ether herbicide of total weight of the composition.

9. The composition as claimed in claim 1, wherein the composition comprises from about 0.1% w/v to about 10% w/v dispersing agents of total weight of the composition.

10. The composition as claimed in claim 1, wherein the composition is in a form of a suspension concentrate.

11. A suspension concentrate comprising:
(a) pyroxasulfone;
(b) diflufenican;
(c) fatty alcohol ethoxylate;
(d) ethylene oxide/propylene oxide block copolymer; and
(e) at least one agrochemically acceptable excipient.

12. The composition as claimed in claim 11, wherein the fatty alcohol ethoxylate and the ethylene oxide/propylene oxide block copolymer are present in a weight ratio ranging from about 0.5:10 to about 10:0.5.

13. A process for preparing a herbicidal composition, the process comprising:
(a) adding a solvent along with at least one dispersing agent and at least one agrochemically acceptable excipient to form a mixture and homogenizing the mixture;
(b) adding at least one isoxazoline herbicide and at least one phenyl ether herbicide to the mixture and homogenizing the mixture to form a uniform slurry; and
(c) milling the slurry at a temperature from about 15° C. to about 35° C. to get required particle size and collecting it in a gelling vessel to obtain a herbicidal composition.

14. Use of a herbicidal composition for controlling weeds, the composition comprising:
(a) at least one isoxazoline herbicide;
(b) at least one phenyl ether herbicide;
(c) at least one dispersing agent; and
(d) at least one agrochemically acceptable excipient.

15. A method for controlling weeds by applying an effective amount of a herbicidal composition to a plant or a locus thereof, the composition comprising:
(a) at least one isoxazoline herbicide;
(b) at least one phenyl ether herbicide;
(c) at least one dispersing agent; and
(d) at least one agrochemically acceptable excipient.
